(19) United States
(12) Patent Application Publication
(10) Pub. No.: US 2017/0124494 A1
(43) Pub. Date: May 4, 2017

(54) SYSTEMS, METHODS AND DEVICES FOR MODELLING OPERATIONAL RISK

(71) Applicant: ROYAL BANK OF CANADA, Montreal (CA)

(72) Inventors: James HRISTOSKOV, Toronto (CA); Kirill MAYOROV, Mississauga (CA)

(21) Appl. No.: 14/926,661

(22) Filed: Oct. 29, 2015

(51) Int. Cl. G06Q 10/06

(52) U.S. Cl. CPC G06Q 10/0635; G06Q 10/067

(57) ABSTRACT

Methods for modelling operational risk can includes: retrieving external loss data from at least one external data source; retrieving internal loss data from at least one internal data source; generating, with at least one processor, mapped loss data by mapping the internal and external loss data by at least one of: source, unit and time period for unit-of-measure processing; storing the mapped loss data in at least one memory; conducting, with the at least one processor, model parameterization and exploratory data analysis on the mapped loss data to generate loss models based on the mapping; performing a simulation across the loss models to convolve frequency and severity components into an aggregate loss distribution; storing the aggregate loss distribution in the at least one memory; and producing a measure of operational risk based on the aggregate loss distribution.

### FIELD

Aspects of the present disclosure relate to the field of operational risk management and particularly to systems, methods, devices and computer-readable media that model operational risk.

### BACKGROUND

Institutions such as banks have various lines of business which may be subject to different classes of operational risks. The Advanced Measurement Approaches (AMA) set out by the Basel II Capital Accord is an operational risk assessment framework which identifies a series of problems for the financial industry to solve relative to risk modelling.

Risks can be associated with distributions, and modelling for such risk for a large organization can require computational-heavy and time-consuming simulation models. Alternatives which can reduce computation, have shorter run times, or may be more credible would be beneficial.

### SUMMARY

In accordance with an aspect, a method for modelling operational risk is provided. The method includes: retrieving external loss data from at least one external data source; retrieving internal loss data from at least one internal data source; generating, with at least one processor, mapped loss data by mapping the internal and external loss data by at least one of: source, unit and time period for unit-of-measure processing; storing the mapped loss data in at least one memory; conducting, with the at least one processor, model parameterization and exploratory data analysis on the mapped loss data to generate loss models based on the mapping; performing a simulation across the loss models to convolve frequency and severity components into an aggregate loss distribution; storing the aggregate loss distribution in the at least one memory; and producing a measure of operational risk based on the aggregate loss distribution.

In accordance with another aspect, a device for modelling operational risk is provided. The device includes: at least one memory; and at least one processor. The at least one processor is configured for: retrieving external loss data from at least one external data source; retrieving internal loss data from at least one internal data source; generating mapped loss data by mapping the internal and external loss data by at least one of: source, unit and time period for unit-of-measure processing; storing the mapped loss data in the at least one memory; conducting model parameterization and exploratory data analysis on the mapped loss data to generate loss models based on the mapping; performing a simulation across the loss models to convolve frequency and severity components into an aggregate loss distribution; storing the aggregate loss distribution in the at least one memory; and producing a measure of operational risk based on the aggregate loss distribution.

In accordance with another aspect, a non-transitory, computer-readable medium or media is provided. The medium or media has stored thereon instructions which when executed by at least one processor configure the at least one processor for: retrieving external loss data from at least one external data source; retrieving internal loss data from at least one internal data source; generating, with at least one processor, mapped loss data by mapping the internal and external loss data by at least one of: source, unit and time period for unit-of-measure processing; storing the mapped loss data in at least one memory; conducting, with the at least one processor, model parameterization and exploratory data analysis on the mapped loss data to generate loss models based on the mapping; performing a simulation across the loss models to convolve frequency and severity components into an aggregate loss distribution; storing the aggregate loss distribution in the at least one memory; and producing a measure of operational risk based on the aggregate loss distribution.

In various further aspects, the disclosure provides corresponding systems and devices, and logic structures such as machine-executable coded instruction sets for implementing such systems, devices, and methods.

In this respect, before explaining at least one embodiment in detail, it is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures.

FIG. 1 is a block diagram illustrating aspects of an example system according to some embodiments.

FIG. 2 is a flowchart depicting aspects of an example method according to some embodiments.

FIG. 3 is a schematic diagram showing aspects of an example of computing device, exemplary of an embodiment.

### DETAILED DESCRIPTION

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, systems, methods, devices, and computer-readable media are provided generally in relation to operational risk management and more particularly, in relation to modelling and/or providing alerts or indications associated with the management of operational risk.

In some embodiments, the framework described herein may be based on Loss Distribution Approach (LDA) under Basel/OSFI (Office of the Superintendent of Financial Institutions) guidelines. Aspects of the present disclosure may relate to testing the goodness-of-fit (GoF) of a distributional family to operational loss data. In some embodiments, systems, methods, devices, and computer-readable media described herein may provide a framework which can manage a device's handling of operational loss models in a manner which may be computationally faster, more efficient and/or more accurate.

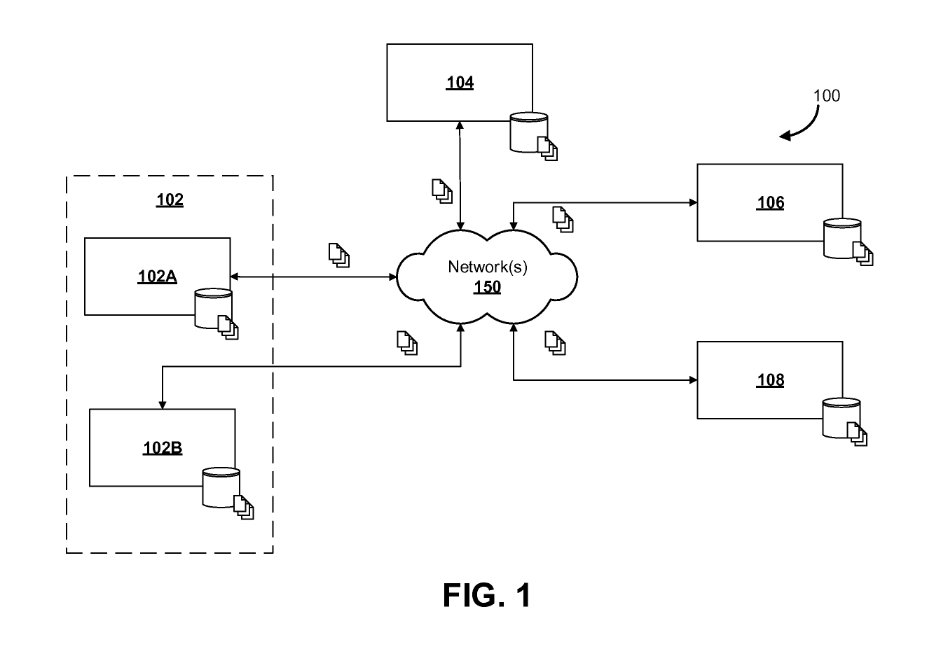

FIG. 1 is a block diagram illustrating aspects of an example system 100 including aspects suitable for use in modelling operational risk. As illustrated in the embodiment shown, the system 100 can include one or more systems or devices 102, 102A, 102B, 104, 106, 108, and network(s) 150. Some systems, devices and/or networks may be associated with one or more entities, for example financial institutions, insurance companies, etc. The systems and devices 102, 102A, 102B, 104, 106, 108 may include computing resources such as computers, servers, mainframes, mobile devices, multiprocessor systems, shared or distributed computing resources, data sources, data storage devices, memory devices, and the like.

In some embodiments, a system 102 or group of devices 102A, 102B, network(s) 150, and/or shared resources may be associated with an entity such as a bank. Loss data associated with the entity can be treated as internal loss data, and loss data associated with a different entity or an unassociated device/system can be treated as external loss data.

The systems and devices can, in some embodiments, include one or more processors in a single device or split across any number of devices in the system. These processor(s) can be configured to perform one or more aspects of an operational risk management/modelling process.

The systems/devices may be connected over any suitable connection including over data bus(ses), local connection(s), communication network(s), and the like.

In some embodiments, the system(s) or device(s) may include one or more processor(s), memory/storage device(s), input/output interface(s), input device(s), resource(s) and/or any other devices or mechanisms suitable for or involved in performing aspects of the methods and functions described herein.

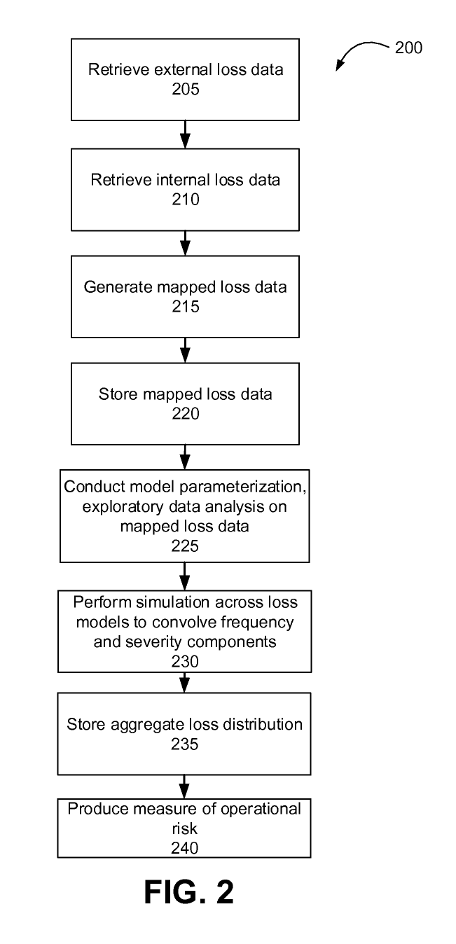

FIG. 2 depicts a flowchart illustrating aspects of an example method 200 for modelling operational risk. At 205 and 210, processor(s) associated with an entity retrieve loss data. External loss data can include data regarding an actual loss experienced by an external entity, and internal loss data can include data regarding an actual loss experienced by the entity itself. Internal and/or external loss data can, in some embodiments, include business line and/or unit(s), loss type and/or category(ies), loss amount, exchange rate, loss occurrence date, loss detection date, associated people/processes/systems/group, geographic and/or political region, consumer price indices, cause(s), risk class(es) and/or any other suitable data associated with a loss or near loss. In some embodiments, loss data regarding an internal loss may include more data and loss data regarding an external loss.

In some examples, the external loss data can be retrieved or otherwise obtained from device(s), system(s) associated with those other entities. In some examples, the external loss data can be aggregated at one or more central data sources such as a device/system 104 associated with the Operational Riskdata eXchange Association (ORX). In some examples, the external loss data can be retrieved continuously, periodically and/or in real or near-real time. In some examples, the external loss data can be stored internally at a system/device associated with the entity and can be updated whenever new data is received. In some examples, retrieving external loss data from an external data source can include retrieved an internal copy of the external loss data.

In some embodiments, internal loss data can be received, aggregated, compiled or otherwise obtained from one or more device(s)/system(s) associated with the entity.

At 215, processor(s) generate mapped loss data from the internal and external loss data. In some embodiments, this can include generating a mapping based on one or more categories of loss data for unit-of-measure (UOM) processing. In some embodiments, the mapping can be generated based on at least one of source, unit, and time period. In some examples, generating the mapping can include translating, converting, rearranging or otherwise calibrating the loss data so that it is suitable for unit-of-measure processing. In some examples, this may allow for more rapid data extraction and/or unit-of-measure processing.

In some embodiments, generation of the loss data mapping can be done periodically, continuously, upon receipt of a request and/or when new loss data is retrieved.

At 220, processor(s) can store the mapped loss data in at least one memory. In some examples, the at least one memory can be a storage device at a computing device such as a hard drive, solid state memory, flash drive, optical drive, tape drive, other non-volatile memory(ies) and the like. In some examples, the at least one memory can include a cache or volatile memory such as RAM (random-access memory), and the like.

In some examples, the mapped loss data can be stored at a memory of a computing, storage or other device via one or more network(s) 150. Such memory(ies) can include cloud storage, network attached storage, etc.

At 225, processor(s) conduct model parameterization and/or exploratory data analysis (EDA) on the mapped loss data to generate loss models. In some examples, EDA and model parameterization can include analyzing, estimating and/or generating different loss models based on the mapped loss data. In some embodiments, the loss models can include models for frequency, severity, correlations and/or potential losses. The loss models can, in some examples, be modelled for each UOM. In some examples, the UOMs can be based on time period sizes, source, unit, etc.

In some examples, the loss models can be based on different levels of granularity. For example, granular levels can include regional or political boundaries, people/group/unit risks, etc.

Processor(s) can generate frequency and severity models by estimating probability distributions and selecting an appropriate frequency model and severity distribution for each UOM. Processor(s) can generate correlation models which captures inter and intra relationships of various UOMs. The correlation models may includes testing frequency autocorrelation, frequency-to-severity correlation, frequency to frequency correlations and/or inter-business line loss correlations across cells/UOMs.

In some examples, model parameterization and/or EDA can include regression analysis such as linear regression, upper tail analysis, fat tail regression, frequency regression, or other models.

In some examples, model parameterization and/or EDA can be based on one or more parameters. These parameters can be defined by the system/processor(s) or through administrator input. In some examples, the parameters can include clustering, internal/external severity distribution weighting, severity distribution selections, and the like.

At 230, processor(s) perform simulations across one or more of the loss models to convolve frequency and severity components into an aggregate loss distribution. In some embodiments, the simulations can include value-at-risk (VaR) simulation(s) of loss aggregates across all UOMs. The VaR can, in some examples, be calculated through the aggregate loss distribution using a Student-t copula applied at the Business Lines level. In some examples, defined operational risk loss scenarios or parameters can inform the severity profiles used in the VaR simulation or may confirm that the severity selections are inline with expected views.

At 235, the aggregate loss distribution(s) can be stored in at least one memory. similar to the mapped loss data or otherwise. In some examples, the at least one memory can be a storage device at a computing device such as a hard drive, solid state memory, flash drive, optical drive, tape drive, other non-volatile memory(ies) and the like. In some examples, the at least one memory can include a cache or volatile memory such as RAM (random-access memory), and the like.

In some examples, the aggregate loss distribution(s) can be stored at a memory of a computing, storage or other device via one or more network(s) 150. Such memory(ies) can include cloud storage, network attached storage, etc.

At 240, processors produce a measure of operational risk based on the aggregate loss distribution(s). In some examples, the loss distributions of each cell can be combined to determine the overall diversified regulatory capital.

In some embodiments, the VaR results at the 99.9 percentile from these correlated loss simulations can then be allocated among the business lines to meet Pillar 1 regulatory requirements.

In some embodiments, processor(s) can generate message or otherwise communicate measure(s) of operational risk to one or more devices/systems and/or output devices.

In some embodiments, the measure of operational risk can be used to determine whether one or more units of the entity or the entity as a whole meets regulatory requirements such as capital reserve requirements.

In some embodiments, if reserve requirements are not met, or if capital reserves and within a defined threshold, processor(s) can be configured to generate an alert. Such alerts can include generating an email or other message(s), generating a displayed warning or message, generating a log entry, generating an audible alert, and the like.

In some embodiments, processor(s) can be configured to generate reports or logs and/or to pause or otherwise allow an administrator to review various stages of the process such as the parameterization, correlation modelling, VaR simulation and aggregations and measure of operational risk. In some examples, the processor(s) can receive input(s) to modify one or more parameters at one or more stages. In some examples, business environment and internal control factors (BEICF) can be used to facilitate forward-looking measures and/or to provide credible representation(s) of forward-looking operational risk exposure. In some examples, inputs can be received to adjust parameters to reflect business and/or regulatory conditions.

In some embodiments, one or more of the aspects shown in FIG. 2, or other aspects can include selecting a severity distribution. The distribution ideally will best reflect the behavior of losses in the upper tail. The processor(s) can be configured to select a severity distribution by applying a goodness-of-fit (GOF) test.

In some examples, the processors can apply a GOF test belonging to the family of weighted Cramer-van Mises tests. With such a test, the processor(s) can evaluate the GOF of a cumulative distribution function F(, θ) compared to a given empirical distribution function Fₙ().

For simplicity, it may be assumed that ℑ is a parametric family, i.e., ℑ={F(,θ),θεΘ}, where Θ is an open set in [symbol] ^{d} and F(, θ) is the cumulative distributive function (“cdf”). This can also be formulated as H₀: F(x)εℑ (with a suitable alternative). For a random sample of size n, the test statistic is then

$${Q}_{n}^{1.5} = n {\int }_{- ∞}^{+ ∞} \frac{{( {F}_{n} ( x ) - F ( x , θ ) )}^{2}}{{( 1 - F ( x , θ ) )}^{1.5}} d F ( x , θ ) , \qquad ( 1 )$$

Where n and Fₙ(), are the sample size and empirical cdf, respectively, and Q is a test statistic for the GOF test.

In theoretical statistics, such tests have been known in generality as Qₙ^{β} for 0≦β<2 based on a series of works of Deheuvels and Martynov. Chernobai suggested using Qₙ² in the context of Operational Risk.

To test whether data arises from a distribution family, an estimate of θ can be applied to F; however this may not detect significant departures from a null hypothesis. Accordingly, in some embodiments, processor(s) are configured to obtain an estimate of θ and determine a test statistic by applying it to F. The processor(s) can obtain samples of F (with the estimate of θ applied), and applying a new estimate of θ in a Monte Carlo approach. From this, the processor(s) can approximate p-values for the asymptotic distribution of equation (1). In some examples, this may be a computationally heavy process.

In some embodiments, the processor(s) can approximate a covariance matrix of the integral operator in (1) corresponding to the asymptotic distribution by applying jackknife estimations and influence functions. In some embodiments, the processor(s) find the matrix's eigenvalues and can approximate the p-value by applying saddlepoint approximation.

The embodiments of the devices, systems, media and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium or media. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein may be implemented by physical computer hardware, including computing devices, servers, receivers, transmitters, processors, memory, displays, and networks. Some embodiments described herein provide useful physical machines and particularly configured computer hardware arrangements. Some embodiments described herein are directed to electronic machines and methods implemented by electronic machines adapted for processing and transforming electromagnetic signals which represent various types of information. Some embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations may be clearly essential elements of some embodiments described herein, and they cannot be omitted or substituted for mental means without having a material effect on the operation and structure of the embodiments described herein. In some embodiments, the computer hardware is essential to implement the various embodiments described herein and is not merely used to perform steps expeditiously and in an efficient manner. For example, it may be impractical and unreasonable to consider human implementation for computationally complex encryption and/or decryption, or maintaining and/or accessing vast databases of data with myriad interrelationships.

For simplicity only one computing device 500 is shown but system may include more computing devices 500 operable by users to access remote network resources and exchange data. The computing devices 500 may be the same or different types of devices. The computing device 500 at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

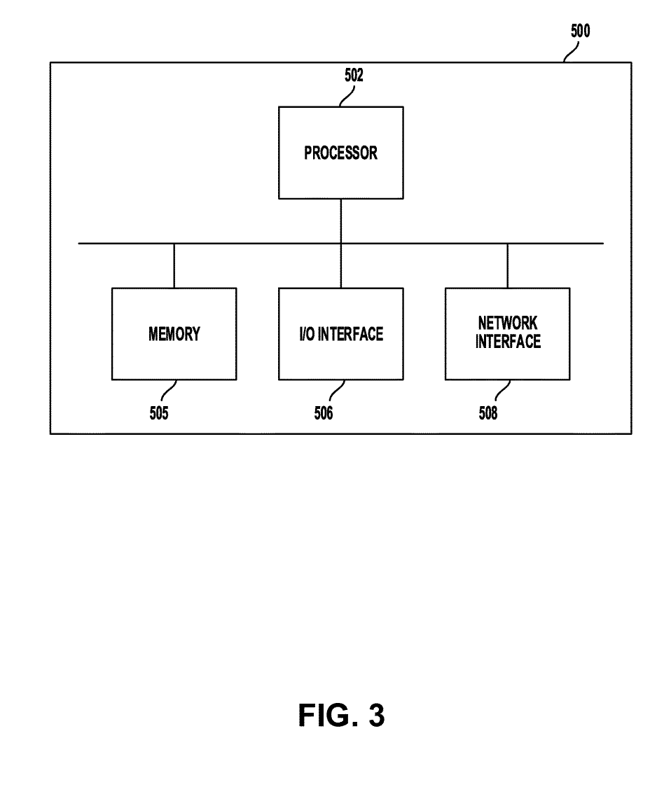

FIG. 3 is a schematic diagram of computing device 500, exemplary of an embodiment. As depicted, computing device 4 includes at least one processor 502, memory 504, at least one I/O interface 506, and at least one network interface 508.

Each processor 502 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 504 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 506 enables computing device 500 to interconnect with one or more input devices, such as a keyboard, mouse, camera, touch screen and a microphone, or with one or more output devices such as a display screen and a speaker.

Each network interface 508 enables computing device 500 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Computing device 500 is operable to register and authenticate users (using a login, unique identifier, and password for example) prior to providing access to applications, a local network, network resources, other networks and network security devices. Computing devices 4 may serve one user or multiple users.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A method for modelling operational risk, the method comprising:
retrieving external loss data from at least one external data source;
retrieving internal loss data from at least one internal data source;
generating, with at least one processor, mapped loss data by mapping the internal and external loss data by at least one of: source, unit and time period for unit-of-measure processing;
storing the mapped loss data in at least one memory;
conducting, with the at least one processor, model parameterization and exploratory data analysis on the mapped loss data to generate loss models based on the mapping;
performing a simulation across the loss models to convolve frequency and severity components into an aggregate loss distribution;
storing the aggregate loss distribution in the at least one memory; and
producing a measure of operational risk based on the aggregate loss distribution.

2. The method of claim 1 comprising: conducting a goodness-of-fit test.

3. The method of claim 2 wherein the goodness-of-fit test is based on the equation:
$${Q}_{n}^{1.5} = n {\int }_{- ∞}^{+ ∞} \frac{{( {F}_{n} ( x ) - F ( x , θ ) )}^{2}}{{( 1 - F ( x , θ ) )}^{1.5}} d F ( x , θ ) ,$$
wherein Q is a test statistic for the goodness-of-fit test; n is a sample size; and F is a cumulative distributive function.

4. The method of claim 3 comprising: approximating with the at least one processor p-values of the equation based on an asymptotic distribution.

5. The method of claim 4 comprising: approximating with the at least one processor a covariance matrix of the integral operation in the equation corresponding to the asymptotic distributions using jackknife estimation and influence functions.

6. The method of claim 5 comprising: finding eigenvalues of the covariance matrix.

7. The method of claim 4 comprising: approximating the p-values based on a saddlepoint approximation.

8. The method of claim 1, comprising: generating an alert when the measure of operational risk meets a trigger condition.

9. A device for modelling operational risk, the device comprising:
at least one memory; and
at least one processor configured for:
retrieving external loss data from at least one external data source;
retrieving internal loss data from at least one internal data source;
generating mapped loss data by mapping the internal and external loss data by at least one of: source, unit and time period for unit-of-measure processing;
storing the mapped loss data in the at least one memory;
conducting model parameterization and exploratory data analysis on the mapped loss data to generate loss models based on the mapping;
performing a simulation across the loss models to convolve frequency and severity components into an aggregate loss distribution;
storing the aggregate loss distribution in the at least one memory; and
producing a measure of operational risk based on the aggregate loss distribution.

10. The device of claim 9 wherein the at least one processor is configured for: conducting a goodness-of-fit test.

11. The device of claim 10 wherein the goodness-of-fit test is based on the equation:
$${Q}_{n}^{1.5} = n {\int }_{- ∞}^{+ ∞} \frac{{( {F}_{n} ( x ) - F ( x , θ ) )}^{2}}{{( 1 - F ( x , θ ) )}^{1.5}} d F ( x , θ ) ,$$
wherein Q is a test statistic for the goodness-of-fit test; n is a sample size; and F is a cumulative distributive function.

12. The device of claim 11 wherein the at least one processor is configured for: approximating with the at least one processor p-values of the equation based on an asymptotic distribution.

13. The device of claim 12 wherein the at least one processor is configured for: approximating with the at least one processor a covariance matrix of the integral operation in the equation corresponding to the asymptotic distributions using jackknife estimation and influence functions.

14. The device of claim 13 wherein the at least one processor is configured for: finding eigenvalues of the covariance matrix.

15. The device of claim 12 wherein the at least one processor is configured for: approximating the p-values based on a saddlepoint approximation.

16. The device of claim 9, wherein the at least one processor is configured for: generating an alert when the measure of operational risk meets a trigger condition.

17. A non-transitory, computer-readable medium or media having stored thereon instructions which when executed by at least one processor configure the at least one processor for:
retrieving external loss data from at least one external data source;
retrieving internal loss data from at least one internal data source;
generating, with at least one processor, mapped loss data by mapping the internal and external loss data by at least one of: source, unit and time period for unit-of-measure processing;
storing the mapped loss data in at least one memory;
conducting, with the at least one processor, model parameterization and exploratory data analysis on the mapped loss data to generate loss models based on the mapping;
performing a simulation across the loss models to convolve frequency and severity components into an aggregate loss distribution;
storing the aggregate loss distribution in the at least one memory; and
producing a measure of operational risk based on the aggregate loss distribution.

18. The medium or media of claim 17 wherein the instructions configure the at least one processor for: conducting a goodness-of-fit test based on the equation:
$${Q}_{n}^{1.5} = n {\int }_{- ∞}^{+ ∞} \frac{{( {F}_{n} ( x ) - F ( x , θ ) )}^{2}}{{( 1 - F ( x , θ ) )}^{1.5}} d F ( x , θ ) ,$$
wherein Q is a test statistic for the goodness-of-fit test; n is a sample size; and F is a cumulative distributive function.

19. The medium or media of claim 18 wherein the instructions configure the at least one processor for: approximating with the at least one processor p-values of the equation based on an asymptotic distribution.

20. The medium or media of claim 18 wherein the instructions configure the at least one processor for: approximating with the at least one processor a covariance matrix of the integral operation in the equation corresponding to the asymptotic distributions using jackknife estimation and influence functions.
